(19) United States
(12) Patent Application Publication
(10) Pub. No.: US 2014/0183278 A1
(43) Pub. Date: Jul. 3, 2014

(54) Perforated fluid dispensing hose or tube for the purpose of applying liquids and/or gases to railroad tracks including railroad switches, railroad crossings, bridge overheads and tunnel walls

(71) Applicant: Clive Sofus Michelsen, Limhamn (SE)

(72) Inventor: Clive Sofus Michelsen, Limhamn (SE)

(21) Appl. No.: 13/733,790

(22) Filed: Jan. 3, 2013

(51) Int. Cl. B05B 13/00; B26D 7/10

(52) U.S. Cl. CPC B05B 13/005; B26D 7/10
USPC 239/282; 239/547; 83/15

(57) ABSTRACT

This invention uses a perforated hose or tube, of various shapes, sizes and wall thicknesses, to evenly and accurately dispense fluids such as lubricants, anti-ice, anti-snow or other liquids and/or gases onto railroad tracks including railroad switches, railroad crossings, bridge overheads, tunnel walls and even roof tops. This is accomplished by fastening or affixing, by clamp or other means, the hoses or tubes along the length of the railroad tracks, railroad switches, railroad crossings, bridge overpasses, tunnel walls and even roof tops for the purpose of manually, automatically and/or remotely controlling liquid or gas application of various amounts and at various frequencies of application. The hoses or tubes are connected to an operational box wherein a communication device, a pump/s, a compressor and reservoir/s of liquid/s and/or gases, such as anti-icing agents, lubricants, and/or other liquids can be delivered. The hoses or tubes can be a single set of hoses or tubes or they can be serially connected via easy connector boxes allowing for multiple spray application points.

### FOREIGN APPLICATION PRIORITY DATA

None

### FILED OF SEARCH

96/179; 104/379; 105/96; 291/3, 11.2, 11.3, 22, 23, 25; 138/40, 42, 111; 184/2, 3.1, 3.2; 222/54, 14, 394; 239/145, 266, 450, 542, 54, 542; 246/415 R, 435 R; 167 R, 168.8, 176, 415 R; 24671 C;

### REFERENCES SITED

U.S. Patent Documents

| | | |
|---|---|---|
| 3,786,618 A * January 1974 | Sommerfeld et al | 96/179 |
| 4,125,176 A * November 1978 | Thrasher, Jr | 184/39.1 |
| 4,195,805 A * April 1980 | Keep | 246/428 |
| 4,199,106 A * April 1980 | Kojimoto et al | 239/542 |
| 4,511,016 A * April 1985 | Doell | 184/6.11 |
| 4,520,901 A * June 1985 | Borup et al | 184/3.1 |
| 4,986,498 A * January 1991 | Rotter et al | 246/458 |
| 5,192,038 A * March 1993 | Nelson et al | 184/3.2 |
| 5,477,941 A * December 1995 | Kumar et al | 184/3.2 |
| 5,842,543 A * December 1998 | Naito et al | 184/3.1 |
| 6,076,637 A * June 2000 | Kumar | 184/3.2 |
| 6,446,754 B1 * September 2002 | Kostelny-Vogts et al | 184/3.1 |
| 6,688,434 B2* February 2004 | Johnson et al | 184/15.3 |
| 7,481,297 B1* January 2009 | Carlton | 184/3.1; 222/ |
| | | 394; 184/3.2 |
| 7,513,335 B2 * April 2009 | Kumar | 184/3.2 |

### BACKGROUND OF THE INVENTION

It is well known that the application of a lubricant to the switch plates or glide plates (FIGS. 4, 8 & 9) improves the function of the switch rail or tongue rail to open and close. Lubricating the moving parts of the railroad switch significantly reduces the rate at which the switch rail becomes worn as it moves back and forth. Lubricating the switch plates therefore reduces this wear.

Railroad switches are located throughout a railroad network and are used to switch trains from one rail to another rail as trains change tracks. In the case of a rail marshaling yard, there can be many switches in close vicinity of one another and schedules maintenance is therefore easier; however, outside of these marshaling yards the location and proximity of railroad switches to one another can vary considerably. These distances make manual lubrication or treatment of anti-ice agents both costly and time consuming for railroad companies maintenance crews. A standard lubrication schedule recommended and used by the majority of railroad companies is to manually lubricate said railroad switches on a monthly basis; however, it is recommended that heavily used switches should be lubricated every two to three weeks.

Using an example to illustrate this point, the Swedish railroad network consists of approximately 12,500 kilometers of track and has around 12,000 railroad switches covering the entire country. Sweden is the longest country in Europe with an approximate length of 1,900 kilometers from Malmo in the south to Kiruna in the north (within the artic circle). Manually lubricating these switches and preparing them with anti-ice agents is both costly and time-consuming. In just considering lubrication for these switches, on the recommended maintenance standards, Sweden's estimated labor costs for lubricating said railroad switches is about 180,720,000.00 Kronor or $27,803,076.00 for labor alone (at today's rate of 6.50 Kronor to US$1.00), not counting the liquid and/or gas. Today, most companies are trying to extend “LEAN” practices in order to save time and money and many of these practices are directed towards maintenance and extending the schedule between lubrication times has become standard practice and railroad switches are now lubricated only every 8 weeks instead of the recommend three to four weeks. The results are well-known: switch failures are more common; switches are in poorer condition, switch replacement is lagging behind schedule, and their lack of lubrication and accumulation of dirt provides additional binding areas for ice to form over during the winter months resulting in railroad switch failure and service delays.

The accumulation of snow and the formation of ice on railroad switches, crossings, tunnel walls, railroad bridges, overpasses can cause significant delays and operating problems. Historically, the approach to addressing these problems has been to use heated switches such as a temperature heating cable disposed lengthwise against the side of the rail. The cable consists of an electrical resistant heating wire encased in a high temperature resistant electrically insulating material confined inside a thermally conductive deformable metal sheath. There are a number of variations of these types of products on the market. In Sweden for instance, the copper-based wire is heated to plus thirty-two degrees Celsius and triggered by a vertical tube sensor that detects snow falling (precipitation). Other ice and snow prevention systems include hot and cold air blowers, gas-fired flames, spraying of glycol de-icing and anti-icing based chemicals, and as a last resort manual removal with brooms and pickaxes (still very common today). All of the above-mentioned systems have inefficiencies since they either require manual operation, overly expensive energy costs in heating the switches twenty-four hours per day since many of the electrical heaters are on full-time throughout the winter. Other methods of manually spraying anti-freeze or de-icing agents to prevent the build-up of ice and snow over and around the railroad has been somewhat successful; however, manually applying the liquid and/or gas is, although less expensive than heaters, not efficient since maintenance crews might need to treat the same switch twice or three times during a heavy snow storm since these chemicals melt about fifteen centimeters per application.

Another method using de-icing or anti-icing chemicals uses a system of spray heads placed at specific points around the switch or a marshaling yard to direct said agent in the direction of the problem area. This method has met with some success however; complete coverage of the switch area cannot be achieved due to factors such as: wind direction, wind speed, and inner mechanics of the switch and crossing itself cannot be reached with basic spraying. Depending upon the approved safety speed for a determined area of the railroad track actual switch lengths can vary from a few meters to over fifty meters in length.

Consequently, there remains a need for an improved method and greater efficiency in and a mechanism for applying liquid and/or gas to railroad switch and switch plates. The present invention addresses all of these needs. All of the foregoing problems could be reduced or eliminated by providing means to apply said liquid and/or gas in a directed and precise manner. Until present, there is no system or solution to offer dual capability wherein a lubricant and an anti-ice liquid and/or gas can be applied from one or the same supplication method to the rail switches and crossings.

### SUMMARY OF THE INVENTION

The invention uses a perforated hose or tube, of various shapes, sizes and wall thicknesses, to evenly and accurately dispense fluids onto railroad switches, railroad crossings, railroad bridge overheads, railroad tunnels and even roof tops. The perforated holes are situated continuously along the length of the hose or tube over the predetermined area. These holes are spaced apart according to the desired spray coverage for the liquid and/or gas used. For example, when lubricating railroad switch plates, number 4, one or more perforated hole/s is/are located a the center of each switch plate consecutively approximately fifty to seventy centimeters apart, see FIG. 9 number 4.2. Since the invention has a dual purpose of applying an anti-ice liquid and/or gas and a lubricant liquid and/or gas to the railroad switches, two hoses or tubes are used. Additional hoses can be added as needed. However, for the sole purpose of preventing snow drifts from approaching the switch rails, only one perforated hose or tube is used on the outer stock rail as indicated in FIG. 8, by number 20. Moreover, if the outer rail facing the on-coming snow-drift is a switch rail then two hoses or tubes are normally used FIG. 8 numbers 6 & 7. Also, this invention allows for the extension of the anti-ice liquid and/or gas hose or tube beyond the switch area to allow for “snow drag.” Snow drag is a snow-drift or snow being pulled into a switch area by a moving train (caused by the train's drag). By increasing the hose or tube lengths beyond the actual switch area (ten to twenty meters depending upon the speed of the track) the spray coverage can be even more effective against snow drag or snow-drift.

In order to have a great degree of flexibility in meeting micro-climate conditions, from plus seventy degrees Celsius (+70° C.) to minus seventy degrees Celsius (−70° C.), the hoses or tubes FIG. 1 through FIG. 10 are and can be manufactured with various wall thicknesses FIG. 1 number 8 to allow for increased pressure as well as flexibility in the design, depth, angle, and shape of the perforated holes to maximize spray patterns FIG. 1 numbers 9 & 10 during various situational temperature changes to which the hoses are exposed throughout the year and in various regions of the world. Hoses and tubes can be selected from a number of materials such as nylon, fluoropolyomer, polyethylene, polyurethane, reinforced polyurethane, pneumatic polyurethane, polyvinyl chloride (PVC), chlorinated polyvinyl chloride (CPVC), cross-linked high-density polyethylene (PEX), polybutylene (PB), acrylonitrile butadiene styrene (ABC), PVC polyester elastomer liner, thermoplastic elastomer, rubber, and combinations thereof. Optional alloys such as steel, stainless steel, copper, iron, galvanized steel, brass, ductile, aluminum, Inconel, and combinations thereof.

This invention provides a method to effectively apply liquids and/or gases to the various parts of a railroad system as mentioned herein. Furthermore, the flexibility of attaching said hoses and the ability to spray difficult to reach areas with said device (hoses and tubes) provides beneficial maintenance advantages not present on other systems. Some benefits are derived from the clamps FIGS. 6, 7, 8 & 9 numbers 15 and 16 in that the hoses are easily removed or replaced if damaged. This method reduces the time spent on the tracks by maintenance since hoses or tubes can be removed or replaced in within a few minutes keeping rail service running. In addition, these hoses or tubes connect by means of an easy connect fitting into an easy connect box adjacent to the railroad switch FIG. 10 number 13.

Since machine to machine communication is so common today, this invention does not see the remote access of this invention as an exclusive invention or an exclusive idea, but rather as a generic method commonly used in many industries today. However, the interactive software, variables (rail temperature FIG. 10 number 12, and the weather station FIG. 10 number 14 and other data) and database driven actions are unique to this dual lubrication anti-ice application method FIG. 10 numbers 22 & 23 and the manufacturing process of said hoses or tubes is unique.

### BRIEF DESCRIPTION OF THE DRAWINGS

FIG. 1 shows a top view, side view, cross-section, angles and hole shapes for the hose and tube invention;

FIG. 2 shows a typical railroad switch indicating the application area;

FIG. 3 shows two marked areas in reference to FIG. 2 where the accumulation and compaction of snow and ice occur on a railroad switch;

FIG. 4 shows a typical railroad switch showing the switch plates and the necessary lubrication area referenced in FIG. 2;

FIG. 5 illustrates a typical railroad switch showing the spray pattern achieved for both the anti-ice and lubrication hoses or tubes as referenced in FIGS. 2, 3 & 4;

FIG. 6 is a close-up diagonal view of a stock rail showing the hose/tube placement and, how it is clamped onto the stock rail, and an illustrated spray pattern and reference in FIGS. 1, 2, 3, 4 & 5;

FIG. 7 is a close-up diagonal view of a switch rail showing hose/tube placement and clamping the various spray holes can be seen at various distances depending upon the desired spray coverage as per FIGS. 1, 2, 3, 4, & 5;

FIG. 8 is a close-up of a cross-section of an open and closed stock and switch rail showing hose/tube placement, spray patterns and liquid and/or gas coverage, and clamps as illustrated in FIGS. 1, 2, 3, 4, 5, 6, & 7;

FIG. 9 is a close-up of a top view of a switch plate, stock and switch rail showing hose/tube position, spray directions, and clamps for a lubricant and an anti-ice liquid and/or gas as indicated in FIGS. 1, 2, 3, 4, 5, 6, 7 & 8.

FIG. 10 is a schematic drawing showing a dual purpose application method using hoses or tubes for the application of liquid and/or gas to a typical railroad switch along with a remote operator's terminal, GPRS communication, reservoir tanks, operational box and track side easy connect box.

### DETAILED DESCRIPTION OF THE REFERRED EMBODIMENTS

For the purpose of promoting an understanding of the principles of the invention and presenting its currently understood “best practice” of operation, the following references will be made to the embodiments illustrated in the drawings. It will nevertheless, be understood that no limitation of the scope or the design of the invention is thereby intended, with such alterations and further applications of the principles of the invention illustrated therein being contemplated as would normally occur to one skilled in the art to which the invention relates.

The present invention is designed to provide an effective way to apply a lubricant, anti-ice agent, deicing agent or gas to railroad switches, crossings (frogs) and other areas. Present methods generally require manual applications at a certain frequency (once a week or month or longer, prior, during after a snow storm). This is labor intensive and leads to irregular maintenance of switches and crossings especially in remote areas.

Without effective lubrication and ice or snow free conditions, switches may not engage fully and rail service grinds to a stop. Without effective ice free conditions tongue rails 2 cannot close, throw rods 3 freeze and crossings become difficult to pass. Currently, these have to be cleaned manually and in poor conditions these can take days to free up and before regular service can resume. An instrumental aspect to this invention is that is provides a simple and effective way to apply lubricants, anti-ice agents, de-ice agents, gasses and other agents to specific hard to reach and general areas of the said areas via a perforated hose or tube.

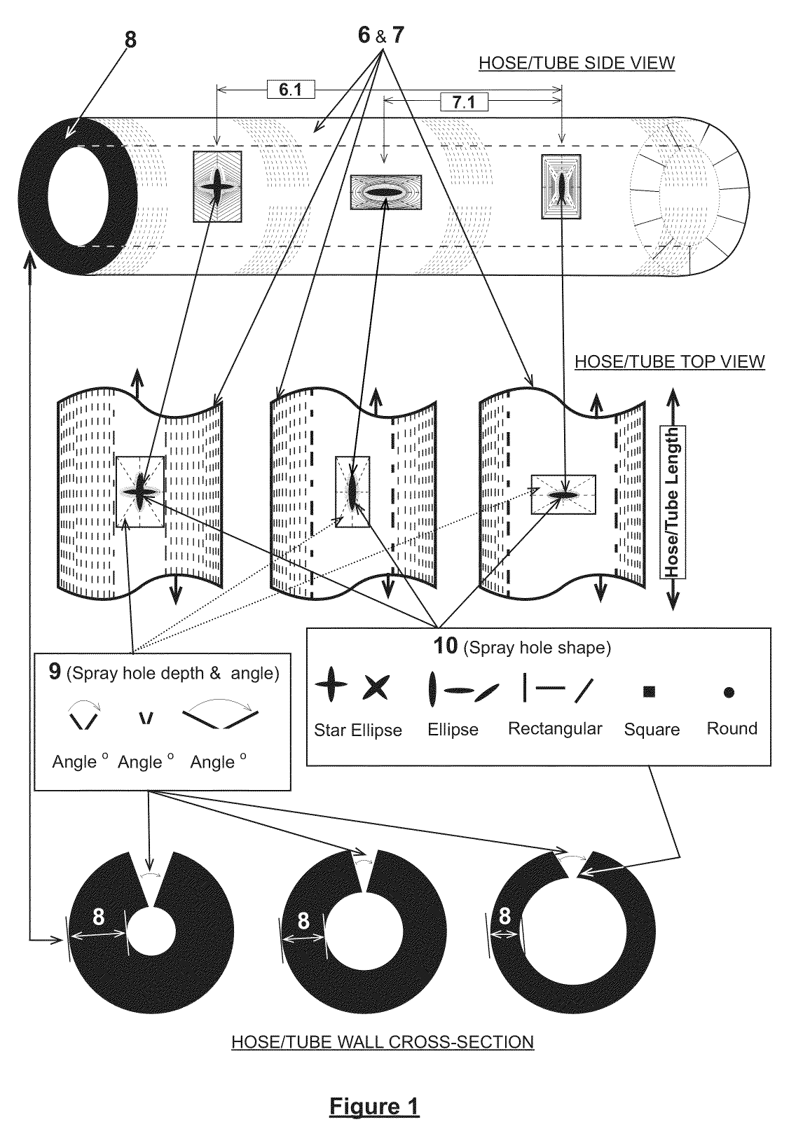

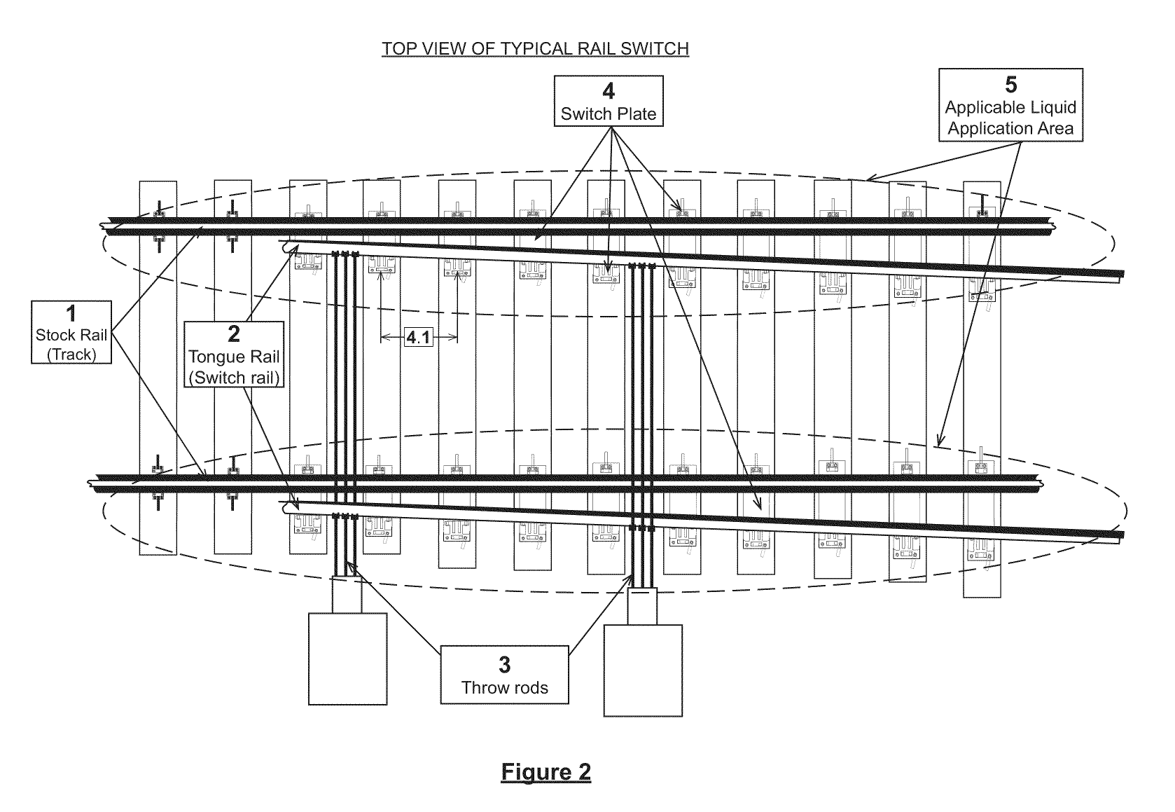

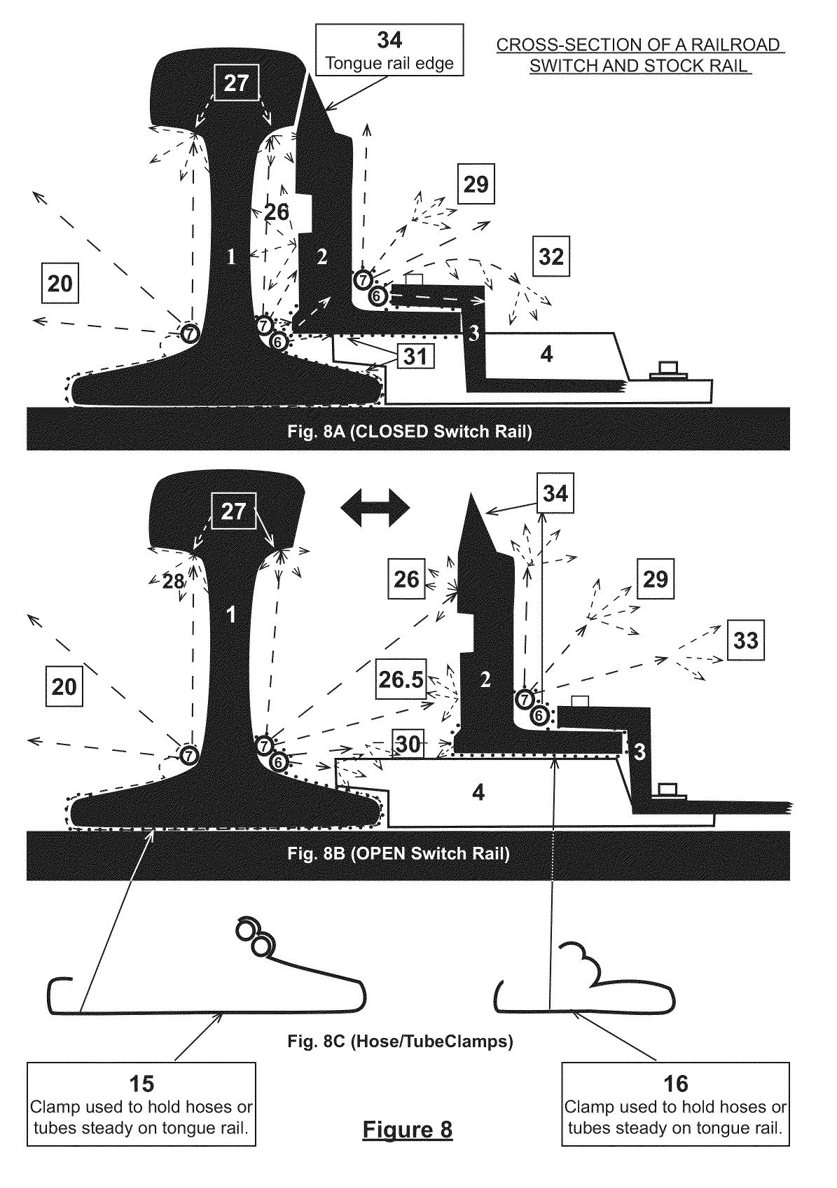

FIG. 1 shows a hose or tube 6 & 7 used for the purpose of applying a lubricant 6 and anti-ice agents and other chemicals or gases 7. For simplicity sake, the illustration shows a small section of one hose or tube with various views (top view, side view and cross-sectional view) as well as the angle applicable to the depth of the perforated holes 9 and the shape or orientation of the perforated holes 10. The perforated holes for hose or tube 6 (used for lubrication) are spaced at intervals 6.1 related to the same distance between the centers of each switch plate FIG. 2 number 4 (the intervals for the perforated holes can vary and are determined by specific railroad standards for each country or switch manufacturer and can be placed anywhere from fifty centimeters (50 cm) to eighty centimeters (80 cm) apart over a predetermined section of the switch). The perforated holes for hose or tube 7 (used for anti-ice or de-icing agents or gases for the same purpose) are spaced at intervals 7.1 wherein their spray pattern and spray coverage intersect with the adjacent perforated holes' spray pattern. This insures complete coverage of or for a predetermined section of the switch rail, crossing or other desired areas. Furthermore, said interval distances vary depending upon the placement of 7 on 1 or 2 and whether or not the function of the spray coverage is to combat snow drifts FIG. 8 number 20 or to increase reflective spray coverage FIG. 8 numbers 26 & 28. Wherein fluid or gas pressure can be increased as needed (burst pressure of 1-200 bars of pressure are determined by the hose type and wall thickness 8 and the type of materials used to manufacture the hoses, however, tubes have a significantly higher pressures than hoses) to allow for a reflective spray (wherein the liquid or gas is bounced off an object to achieve greater coverage) and dependent upon the desired objective. As pressure increases so does the greater distance between said perforated holes increase. For hoses or tubes 6 and 7 the perforated hole's angle 9 can vary and is based upon the desired spray pattern for said liquid, agent and/or gas. The hose's 6 & 7 wall depth 8 and the spray hole angle 9 as well as the spray hole shape and orientation thereof 10 (star ellipse, ellipse, rectangular, square and round used as a single shape or in combination) are all used to create various combinations of spray patterns and liquid or gas coverage and are a unique application method.

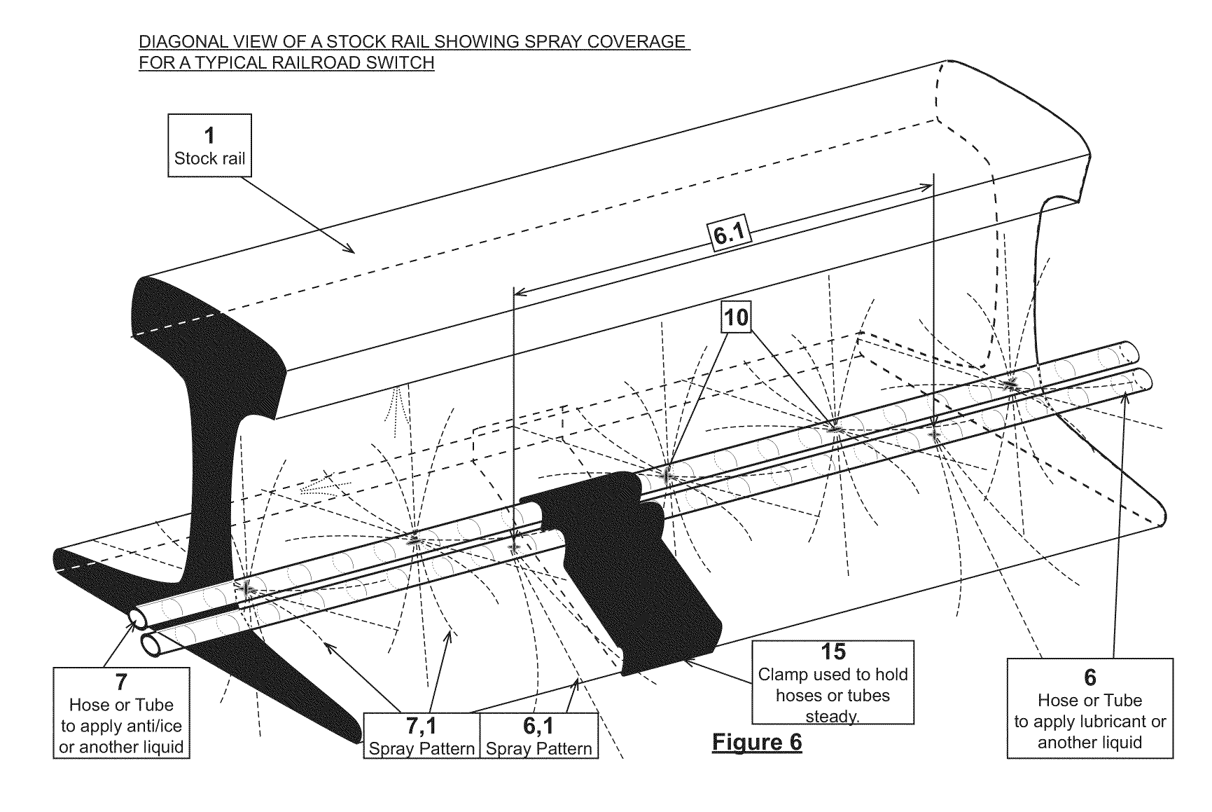

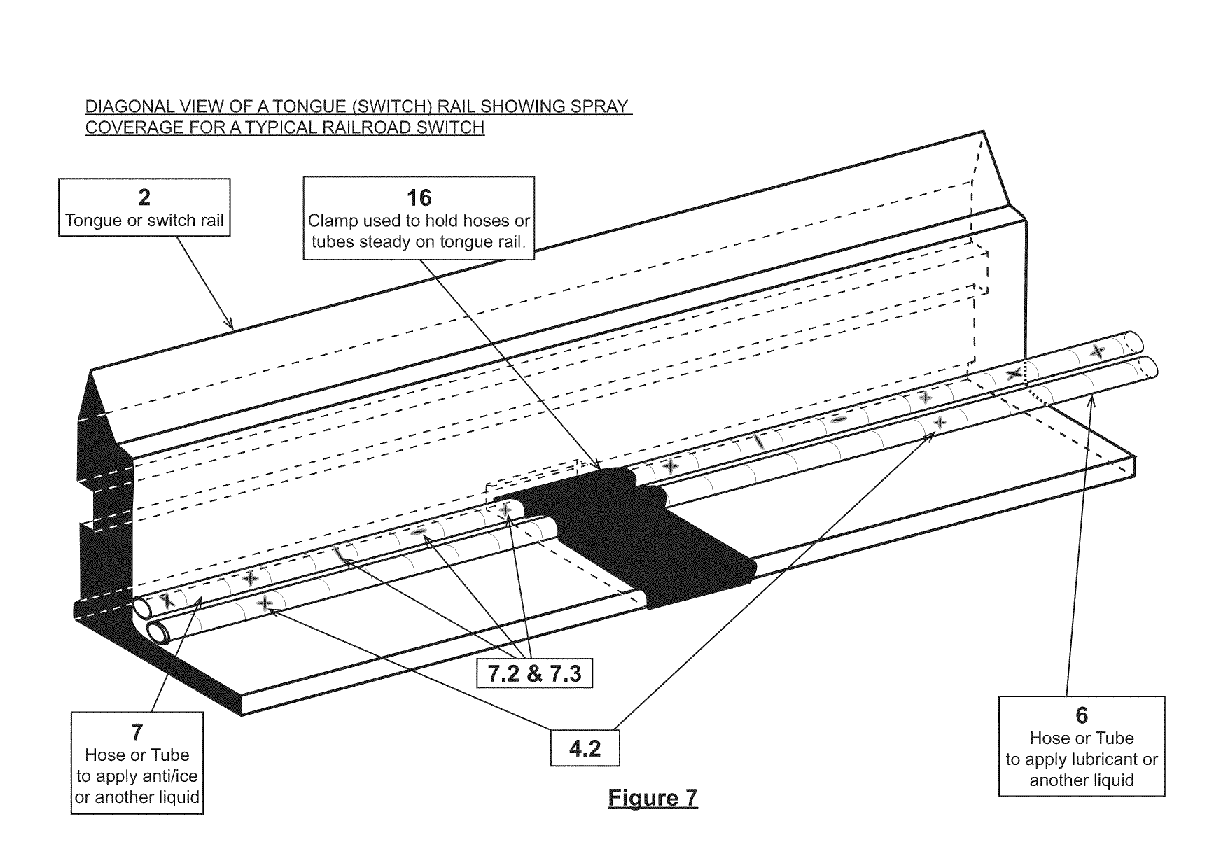

FIG. 2 shows a typical railroad switch compromising of a stock rail 1 (also show in a diagonal close-up in FIG. 6), a tongue or switch rail 2 (also shown in a diagonal close-up in FIG. 7), throw rods 3 used to physically move the switch rail 2 back and forth from a closed position (when fully touching the stock rail) to an open position (when fully apart from the stock rail). Figure two shows an open railroad switch. Switch plates 4, also known as glide plates, allow the switch rail 2, also known as the tongue rail 2, to glide back and forth when moving from a closed to an open position. The encircled area 5 shows the area of concern in relation to lubrication needs and ice and snow accumulation.

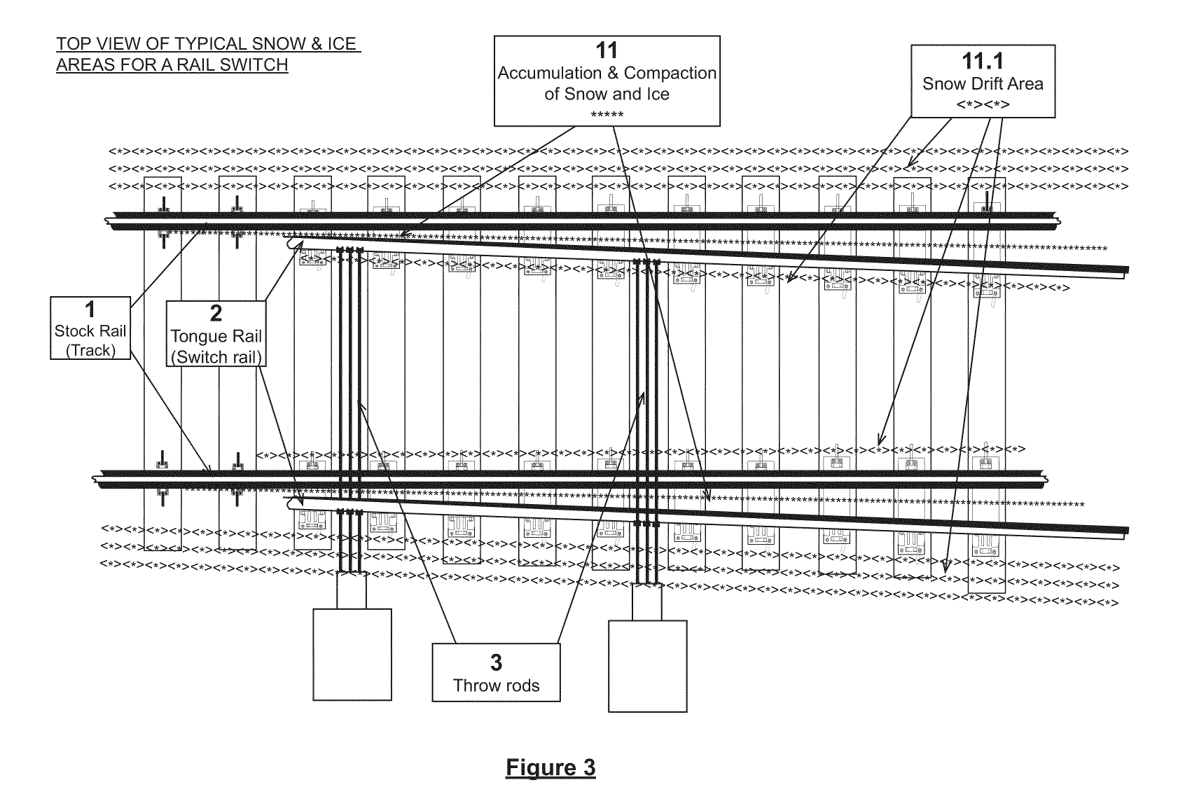

FIG. 3 illustrates the referenced area in FIG. 2 of a typical railroad switch where accumulation of snow 11 & 11.1, and the compaction of snow 11, and the formation of ice 11, and snow drift 11.1, affect normal operation of the switch rail 2. As the switch opens and closes, said snow compacts between the stock rail 1 and the switch rail 2. When snow is compacted between 1 and 2, further snowfall prevents the switch from closing. Also, when ice forms between 1 and 2 it expands and also prevents the switch from closing fully and can even cause the throw rods 3 to freeze. When snow falls on the switch it covers all areas of the switch. During normal situations a switch electrical heater coil (a device that heats the switch rail and stock rail to plus thirty-two degrees Celsius) can melt the falling snow as lands on the rail. However, during heavy snowfalls (greater than twenty centimeters per hour) the snowfall rate exceeds the heated switches capability to melt the snow effectively. The un-melted snow becomes compacted as the switch closes. This compaction 11 is worsened as the runoff water, from the previously melted snow, and due the freezing temperatures, transforms the water and compacted snow into large ice blocks. Currently, these have to be removed by manual methods. Wherein an anti-ice agent is applied to the falling snow, the runoff water will not immediately freeze for some distance from the railroad switch since it is diluted with the anti-freeze agent.

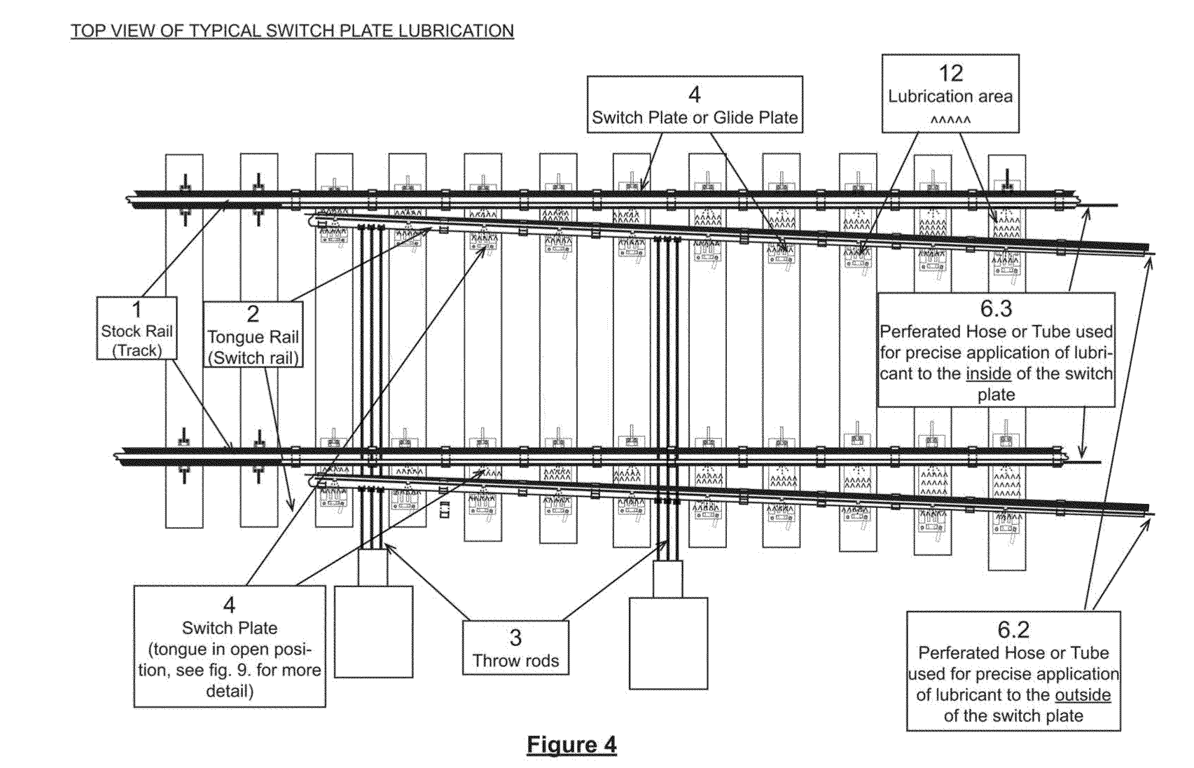

FIG. 4 illustrates the referenced area in FIG. 2 where the switch plates 4 of a typical railroad switch have to be lubricated 12. The switch rails 2 are fitted 6.2 with a perforated 6 hose or tube for the purpose of lubricating the inside section (between the stock rail 1 and the switch rail 2). The stock rails 1 are fitted 6.3 with a perforated 6 hose or tube for the purpose of lubricating the outside or inside portion of the switch plate 4 wherein as the switch rail 2 closes so does the outer-surface of the switch plate area increase. By placing clamping lubrication hoses on both the stock rail 1 and the switch rail 2, total lubrication coverage for the switch plate 4 can be achieved.

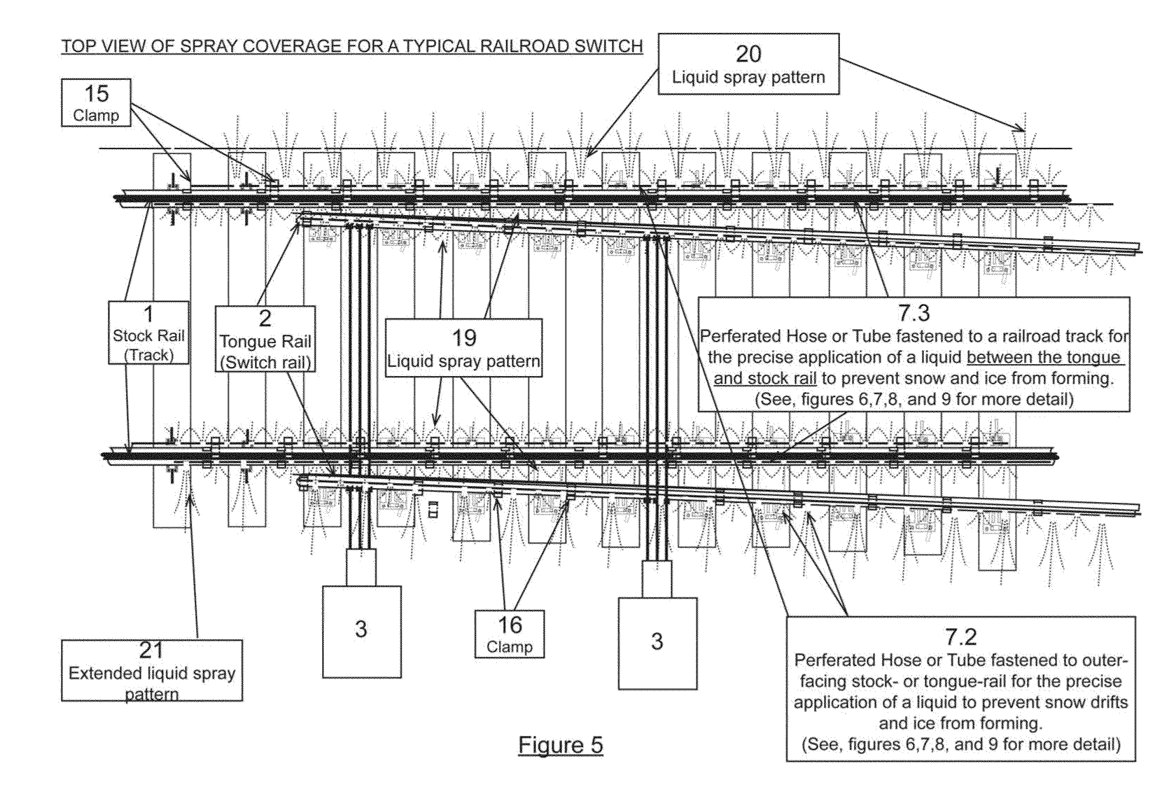

FIG. 5 illustrates the referenced area in FIG. 2 where the outer section of both the stock rail 1 and the switch rail 2 are fitted, by attaching with the use of a clamp 15 or 16, a perforated 7 hose or tube for the purpose of applying an anti-ice, de-icing liquid or gas to the outsides of the railroad tracks to prevent snow drifts from approaching the railroad switch. The predetermined length of the hose or tube 7.2 can increase beyond the switch area so as to prevent snow from the passing trains from being pulled into the switch area. The liquid spray pattern covers a larger area around the outer edge or shoulder of the of the railroad tracks 20 and 21. A perforated hose or tube 7 for the purpose of applying anti-ice, deicing liquid or gas is also fitted and attached, by means of a clamp 15, to the inside of the stock rail 1 that faces a switch rail 2 and also the outside of a stock rail 1 that faces and switch rail 2. The spray patterns 19 indicate coverage of the inside rail section of the switch, between the stock rail 1 and the switch rail 2, for the perforated hose or tube 7.3. However, the spray pattern 19 for 7.2 changes as it passes the tongue at the end of the switch rail 2, since its application objective changes from snow compaction and anti-ice to one of preventing snow-drag and snow-drift as mentioned herein.

FIG. 6 is a close-up diagonal view of a stock rail 1 showing the hose or tube 6 and/or 7 placement and how it is clamped 15 onto the stock rail 1, and an illustrated spray pattern 7.1 shows some coverage of the inside of the stock rail 1. Distance between the perforated holes 6.1 in hose 6 coincide to the center-point of each switch plate. Different shapes or spray patterns are used to maximize spray pattern coverage 10. These differences allow for precise application of liquids and or gases. The clamp 15 is produced from stainless steel or other none corrosive materials and is clamped around the base of the rail for the purpose of holding the hoses or tubes in position and for the purpose of easy replacement by means of a pull and snap-into-place mechanism.

FIG. 7 is a close-up diagonal view of a switch rail 2 showing a perforated 6 & 7 hose or tube placement running the length of the tongue or switch rail 2 and clamped into place using a clamp 16 of various sizes and made from formed stainless steel or other none corrosive materials. The various perforated holes for hose or tube 7 are continuous running a predetermined length of the switch rail 2. The shape 7.2 & 7.3 are determined by the desired spray coverage. Number 4.2 shows fewer perforated holes since these only coincide over a switch plate or area in need of lubrication. The possibility of directing a spray to lubricate the upper edge of the switch rail is also possible.

FIG. 8 is a close-up of a cross-section of closed FIG. 8.A and an open FIG. 8.B railroad stock 1 and switch rail 2 showing hose or tube 6 & 7 placement affixed to the rails 15 & 16 by means of non-corrosive clamps FIG. 8.C.

FIG. 8.A shows a closed switch wherein the stock rail 1 and the switch rail 2 are pushed together. The spray able area is reduced nevertheless effective application of liquids and gases is possible. Number 27 illustrates how hose or tube 7 can use the surface of the switch rail 2 to bounce the spray pattern in increase spray coverage 26 as well as the underside 27 of the stock rail 1. Whereas the anti-ice liquid or gas displacement 26 is bounced off the sides if the switch rail 1 and the underside of the head of the stock rail 27 to produce very good coverage of the metal surface. Whereas the spray pattern and displacement coverage 26 of the anti-ice liquid or gas is evident, the lubricant from hose or tube 6 is sprayed 31 to the underside of the switch rail 2, the base of the stock rail 1 and a section of the switch plate 4. The lubricant is also sprayed on the outside of the switch rail 2 and provides a good lubricant coverage to the outer switch plate 32. There is also a possibility to lubricant the upper tip or leading edge 34 of the switch rail by creating an additional perforated hole specifically for that purpose.

FIG. 8.B shows an open switch wherein the stock rail 1 and the switch rail 2 are apart. Anti-ice liquid or gas from hose or tube 7 is bounced off the switch rail inside surface. It is also bounced off the underside of the stock rail 27 to create liquid coverage of the stock rail and the switch plate 4 with the objective to create good splatter and coverage 26 and 26.5 of the switch rail 2 and with switch plate 4. The outer side of the stock rail 1 (represented here as the outside of the railroad tracks facing the snow drift) receives the greatest amount of pressure to get an adequate amount of anti-ice liquid or gas for complete coverage 20 of up to fifty centimeters from the rail. For close coverage of the base of the stock rail 1, the anti-ice liquid or gas is bounced of the underside of the stock rail 27 to create a liquid disbursement in close proximity to the base as well as a wider spray pattern 20. Lubrication of the exposed switch plate 4 is achieved by directing the spray pattern onto their various areas as wee as to bounce the spray off the inside surface of the switch rail 30. Lubrication pressure and coverage from the switch rail 2 onto the switch plate 4 is reduced on the outside 33 while at the same time the anti-ice spray pattern increases 29. There is also a possibility to lubricant the upper tip or leading edge 34 of the switch rail by creating an additional perforated hole specifically for that purpose.

FIG. 8.C is an illustration of the clips or clamps wherein said hoses or tubes can be easy affixed or removed from the stock rails 1 and switch rails 2. Clip or clamp 15 is used for the stock rail and 16 for the switch rail. Said clamps vary in size and shape in order to adapt to other equipment or obstacles on the rails. Said clamps are manufactured in stainless steel or other alloys, plastics or other non-corrosive materials. Wherein said clamps are bevels and bent to achieve the clipping form or shape required for ease of use in attaching said to the stock rail 1 and the switch rail 2 and primarily as a quick method to click-in and replace hoses or tubes 6 & 7 into position for correct spray position.

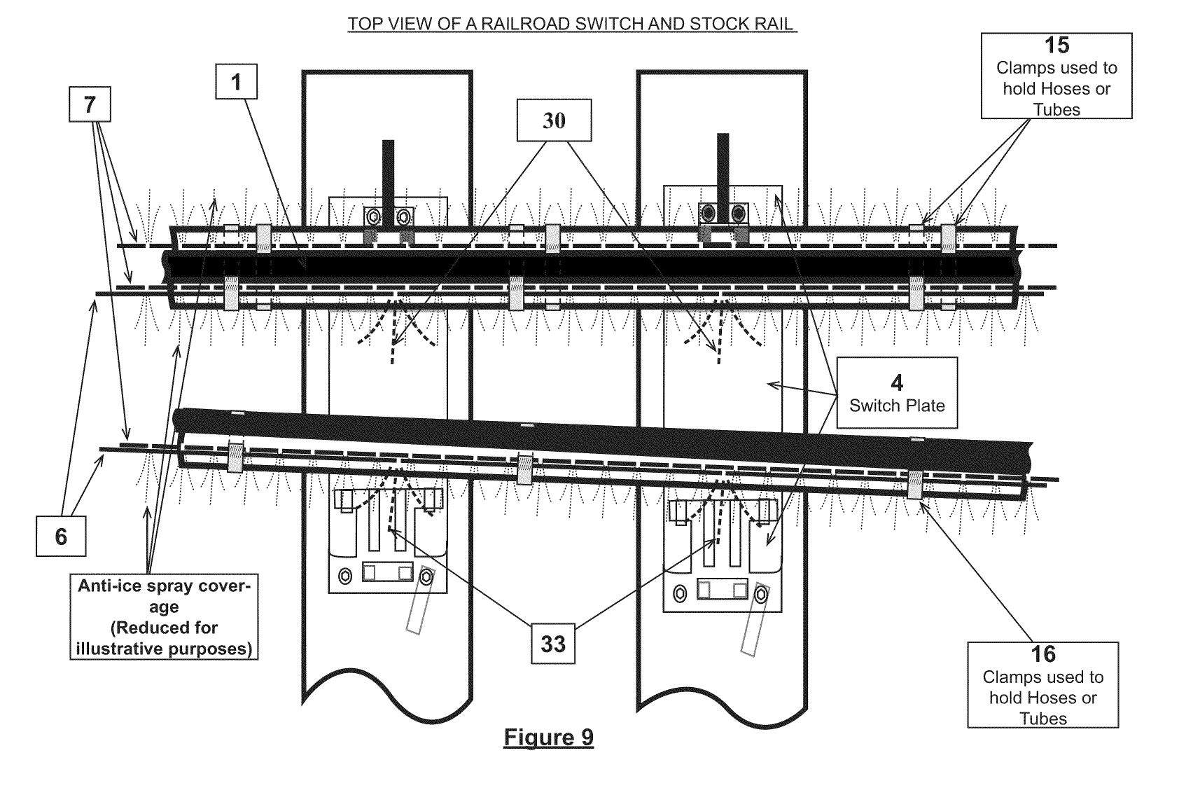

FIG. 9 is a close-up of a top view of a switch plate 4, stock rail 1 and switch rail 2, showing placement and position of hose or tube 6 (lubrication) & 7 (ant-ice), spray directions and coverage (although minimized for illustration purposes). The clamps 15 (stock rail clamps) & 16 (switch plate clamps) used to hold said hoses or tubes into place. Hose or tube 6 illustrates lubrication limited to the inside 30 and outside 33 of the switch plate 4 and space approximately fifty to sixty centimeters apart. Hose or tube 7 show total spray coverage of a liquid for the application of an anti-ice, de-icing or other purposes.

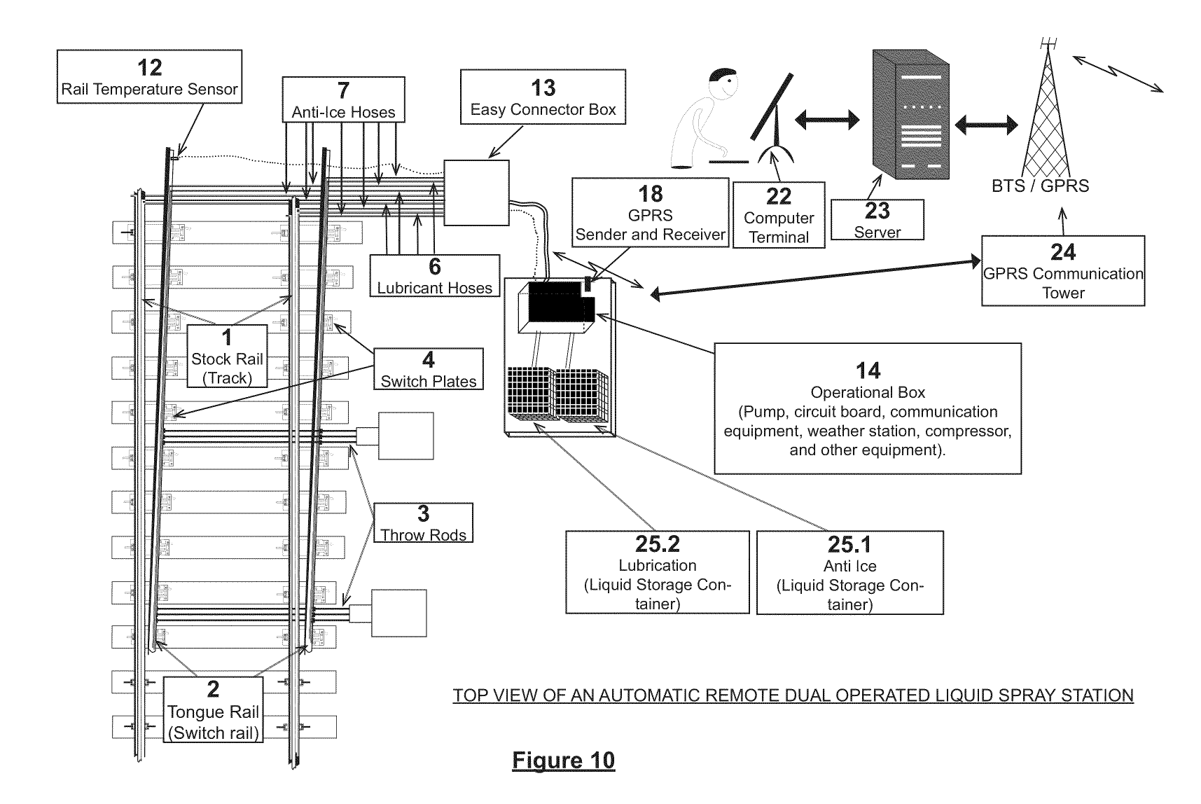

FIG. 10 is a schematic drawing showing a dual purpose application method using hoses or tubes 6 & 7 connection via an easy connect box 13 into an operational box 14 for the application via a pump 14 of liquid and/or compressor 14 for gas from reservoirs 25.1 & 25.2 or other to a typical railroad switch such as stock rails 1 switch rails 2, switch plates 4, and other areas. Wherein a rail temperature sensor 12 is attached to the stock or switch rail to provide up-to-date information on rail temperature. A weather station situation in the section of the operational box 14 uses the information gathered from the weather station such as dew point, temperature, humidity, precipitation, and other information together with the rail temperature to calculate and establish optimal spray times closest to the scheduled time already entered into a database by an end-user. All information is transferred via a circuit board to a GPRS or other communication section within the operational box 14 via a BTS/GPRS communication tower 24 into a programmed database, server 23 and user-friendly software 22 wherein an operator can adjust spray variables, to initiate an immediate spray (prior to a snow storm or multiple spray sessions during extreme weather conditions, for one or all stations connected to the database, or to download statistics and service information.

I claim:

1. A device for applying multiple liquids and/or gases to railroad switches, railroad crossings, railroad bridge-overheads, railroad tunnel-walls, roof tops and other areas.

2. A device as claimed in 1, wherein the device is designed as a hose or tube with perforated holes in said hose or tube and running a predetermined length of said hose or tube.

3. A device as claimed in 2, wherein the perforated holes are designed to produce various spray patterns when under pressure.

4. A device as claimed in 2, wherein the shapes of said perforated holes produce varying spray coverage results.

5. A device as claimed in 2, wherein the hose wall thickness or tube wall thickness varies and its wall diameter is increased or decreased to allow for varied bar pressures and spray coverage.

6. A device as claimed in 2, wherein the hose wall thickness or tube wall thickness varies and its wall diameter is increased or decreased to allow for varied spray patterns.

7. A device as claimed in 2, wherein the angle of said perforated hole in the wall of the hose or tube, leading from the perforated hole shape, on the inside part or lining of the hose or tube wall through the outside of the hose or tube surface, varies in angle to produce varying types of spray coverage and spray results.

8. A device as claimed in 1, wherein the device is fastened or clamped to the stock or switch rail by means of a quick release clip or clamp.

9. A device as claimed in 2, wherein the quick release clip or clamp can enable efficient replacement of said device.

10. A device as claimed in 2, wherein the device can apply various chemicals, agents and gases such as an anti-ice liquid, a lubricant, or any other liquids to areas claimed in 1.

11. A delivery system for the device as claimed in 3 wherein the device is connected to an operational box via an easy connector box for operational purposes. Wherein the connector box serves as an easy connect station for said hoses or tubes, and wherein said connector box can be used as a serial connection point with other connector boxes within a predetermined area, and where the connector box includes various rudimentary mechanics devices as well as solenoid valves.

12. An operational box as claimed in 11 wherein a circuit board (with numerous inputs and outputs), at least one variable pressure pump, a compressor, and digital convertor, communication device such as GPRS, 4G network or other, a weather station to measure various climatic conditions (dew point, humidity, temperature, precipitation, and other variables), and other modifications as needed are included.

13. One or more reservoirs for said chemicals, agents, lubricants or other liquids or gases as claimed in 1 wherein said reservoirs are connected to the pump via solenoid valves and hose or tube into the operational box.

14. Wherein the communication device as claimed in 12 is connected to a server via a communication tower, GRPS station or BTS station for digital transference of measurement data, data, and other operational instructions.

15. Wherein the server is equipped with a data base to send and receive data from said operational box as claimed in 12 via the communication device.

16. Wherein the server as claimed in 15 is connected to a user friendly software package wherein the user can fully operate said operational box from remote location. Wherein spraying parameters can me entered, a schedule for spraying times arranged, maintenance and information is provided and scheduled and other normal operational functions.

17. Wherein the delivery system as claimed in 11 can be serially connected where one operational box can monitor and spray multiple locations within a predetermined area.

18. Wherein the manufacture of said device as claimed in 2 uses various metal objects of various shapes and sizes that are formed to the desired and specific angles and shapes of said perforated holes and that said are heated to various temperatures in order to perforate said hose whereas the surface of said perforated hoses fuses to form a stronger perforated hole than otherwise would occur is said perforated holes were manufactured by other means such hole-punching, laser, water-jet or other methods.
